(19) United States
(12) Patent Application Publication
(10) Pub. No.: US 2026/0286153 A1
(43) Pub. Date: Sep. 24, 2026

(54) ENVIRONMENTALLY FRIENDLY ANTI-MYOPIA INK AND PREPARATION METHOD

(71) Applicant: Xi'an Huaronghui Printing Service Co., Ltd., Xi'an (CN)

(72) Inventor: Xiquan Yu, Xi'an (CN)

(21) Appl. No.: 19/095,441

(22) Filed: Mar. 31, 2025

(30) Foreign Application Priority Data
Mar. 20, 2025 (CN) 202510332272.X

(51) Int. Cl. C09D 11/037; C09D 11/08; C09D 11/102; C09D 11/14

(52) U.S. Cl. CPC C09D 11/037; C09D 11/08; C09D 11/102; C09D 11/14

(57) ABSTRACT

An environmentally friendly anti-myopia ink, comprising the following components in parts by weight: 45-50 parts of epoxy acrylate, 0.5-1 parts of maleic anhydride, 10-15 parts of tannic acid, 18-25 parts of natural rubber latex, 1.5-3 parts of bio-based plasticizer, 15-18 parts of plant-derived yellow pigment, 1-3 parts of blue light absorber, 5-8 parts of silane-modified silica, 0.5-1.5 parts of polyvinyl alcohol and 3-5 parts of pullulan. The invention utilizes various safe and environmentally friendly bio-based materials to construct a multi-layered synergistic protective system. Gardenia yellow and curcumin core-shell pigments serve as the primary protection, covering entire blue light spectrum; silane-modified silica diffuse reflection and pullulan act as the secondary protection, refracting and matching to scatter any residual blue light. The flexibility of tannic acid and epoxy acrylate combined with elasticity of natural rubber form the tertiary protection, reducing the compensatory tension in the optic nerve caused by page-turning vibrations.

### 1. TECHNICAL FIELD

The invention relates to the technical field of ink, in particular to an environmentally friendly anti-myopia ink and a preparation method.

### 2. BACKGROUND ART

In recent years, the global incidence of myopia has continued to rise. According to data from the World Health Organization (WHO), the rate of myopia among adolescents in East Asia has surpassed 80%, and the overall myopia rate among Chinese children and adolescents reached 52.7% in 2020. It is alarming that myopia is showing a significant trend of occurring at younger ages and increasing in severity. Besides genetic factors, environmental and behavioral factors play a dominant role; for instance, there is a surge in close-up visual workload: the widespread use of electronic devices and the decline in outdoor activities have led to adolescents spending more than 8 hours a day on close-up visual tasks; exposure to harmful light environments: children's retinas are sensitive to high-energy blue light (400-450 nm) and short-wavelength light, and long-term exposure can cause photochemical damage and accelerate abnormal axial elongation of the eye; optical defects of traditional printed materials: due to limitations in ink materials, printed items such as schoolwork books exhibit specular reflection and excessively high blue light reflectance, directly inducing visual fatigue and increasing the risk of macular degeneration. Traditional inks pose various hazards. Specifically, the current mainstream printing inks are based on organic pigments, mineral oils, volatile organic compounds (VOCs), and heavy metal additives (such as lead, cadmium, etc.). These inks have dual harmful effects: environmental pollution and health threats: VOC emissions lead to air pollution, and heavy metal residues threaten soil and water safety through bioaccumulation; substances such as benzene solvents, lead, and cadmium can be absorbed through skin contact or the respiratory tract, causing neurotoxicity and developmental disorders in children; visual health risks: high brightness and high contrast printing forces the ciliary muscles to continuously adjust, accelerating the development of myopia; additionally, blue-black ink on yellow paper significantly increases short-wave light reflectance, which substantially adds to visual adjustment burden; the abnormal spectral distribution of colored markers (such as purple and orange) interferes with retinal signal transmission, leading to ciliary muscle spasms. Therefore, based on these problems, it is essential to research environmentally friendly, safety and anti-myopia inks.

### 3. SUMMARY OF THE INVENTION

In view of the defects of the prior art, the invention aims to provide an environmentally friendly anti-myopia ink and a preparation method.

The technical effect of the invention is realized through the following technical scheme: an environmentally friendly anti-myopia ink comprises the following components in parts by weight: 45-50 parts of epoxy acrylate, 0.5-1 parts of maleic anhydride, 10-15 parts of tannic acid, 18-25 parts of natural rubber latex, 1.5-3 parts of bio-based plasticizer, 15-18 parts of plant-derived yellow pigment, 1-3 parts of blue light absorber, 5-8 parts of silane-modified silica, 0.5-1.5 parts of polyvinyl alcohol and 3-5 parts of pullulan.

Preferably, the bio-based plasticizer is any one of acetyl tributyl citrate, acetyl trioctyl citrate, acetyl castor oil methyl ester and epoxidized soybean oil; further, preferably acetyl tributyl citrate.

Preferably, the anti-blue light absorber is Blu-SHIELD B005;

Preferably, the solid content of the natural rubber latex is 60%;

Preferably, the plant-derived yellow pigment is SA@TiO₂ core-shell pigment microcapsule, the SA@TiO₂ core-shell pigment microcapsule is prepared by compounding Gardenia yellow and curcumin and coating with sodium alginate/titanium dioxide core-shell, the specific preparation steps are as follows:
S1: dissolving Gardenia yellow and curcumin in PBS (phosphate-buffered saline), adding 25-30% by volume of anhydrous ethanol and 1.5-2% by volume of Tween-80, heating in a water bath to 40-45° C., stirring to mix evenly, and then homogenizing to obtain a composite dispersion;
S2: dissolving sodium alginate in deionized water, stirring to dissolve evenly, and letting it stand for 1 to 2 hours to obtain a 1 to 1.5 wt % sodium alginate solution; mixing the sodium alginate solution with the composite dispersion prepared in S1, emulsifying at 8000 rpm for 10-15 min, then dropwise adding a 5% CaCl₂ solution, and continue stirring at 300 rpm for 30-50 min to react, thereby obtaining a microcapsule dispersion;
S3: slowly adding 0.1 mol/L of tetrabutyl titanate ethanol solution dropwise into ice bath deionized water, and adjusting the pH to 4.5-5 by using an acetic acid solution to obtain a transparent sol; mixing the transparent sol with the microcapsule dispersion prepared in S2, heating to 50-55° C., adding NaOH solution dropwise to adjust the pH to 7.5-8, stirring slowly at 200 rpm for 2-3 hours, and terminating the reaction by adjusting the pH to 6 with 0.1M hydrochloric acid solution, then centrifuging, filtering, and collecting precipitate, dispersing the precipitate in a water solution containing 1% maltodextrin and 5% glycerol, and spray-drying with an inlet temperature of 110° C. and an outlet temperature of 85 to 90° C. to obtain SA@TiO₂ core-shell pigment microcapsules.

Preferably, in S1, the usage ratio of Gardenia yellow, curcumin and PBS (phosphate-buffered saline) is 2.5-3.5 g:0.8-1.2 g:200 mL, and specific parameters of the homogenization treatment are temperature 35-40° C., pressure 150 MPa, and 2-3 cycles of treatment.

Preferably, in S2, the volume ratio of the sodium alginate solution to the composite dispersion is 1:1; the amount of CaCl₂ solution added is 15-25% of the total volume of the sodium alginate solution and the composite dispersion;

Preferably, in S3, the volume ratio of the tetrabutyl titanate ethanol solution to the ice bath deionized water is 1:10-12; the volume ratio of the transparent sol to the microcapsule dispersion is 1:1.

Preferably, the specific preparation steps of the silane-modified silica are as follows:
S101: dispersing nano-silica into anhydrous ethanol, dispersing it evenly by 200 W ultrasonic treatment for 30-50 min, adding 0.1M hydrochloric acid solution to adjust the pH to 2 to 3, and continuing ultrasonic treatment for 10 min to obtain a suspension;
S102: mixing KH-560 with anhydrous ethanol, stirring to mix uniformly, adding deionized water dropwise, adjusting the pH to 4-4.5 with acetic acid-sodium acetate buffer solution, heating in a water bath to 40-50° C., and stirring to react for 2-3 hours, thereby obtaining a hydrolyzate;
S103: mixing the suspension prepared in S101 with the hydrolyzate prepared in S102, heating to 70-80° C., stirring to react for 6-8 hours, centrifuging, filtering, washing repeatedly with anhydrous ethanol 3 times, and vacuum drying at 60° C. for 12-24 hours to obtain the silane-modified silica.

Preferably, in S101, the usage ratio of nano-silica to anhydrous ethanol is 1 g:30-40 mL.

Preferably, in S102, the volume ratio of KH-560, anhydrous ethanol and deionized water is 1:8-10:1.2-1.5;

Preferably, in S103, the volume ratio of the suspension and the hydrolyzate is 1:3-4.

Preferably, another aspect of the invention provides a preparation method of the environmentally friendly anti-myopia ink, comprising the following specific preparation steps:
S201: adding epoxy acrylate and tannic acid into 20% by weight of propylene glycol methyl ether acetate, heating to 50-60° C. and stirring until completely dissolved, then adding 1.5% triphenylphosphine based on the total weight of the substrate, raising the temperature to 100-120° C. and reacting under nitrogen protection for 4-6 hours, removing the solvent by vacuum distillation at 60° C., washing repeatedly with deionized water three times, and vacuum drying to constant weight, thereby obtaining a tannic acid-epoxy acrylate prepolymer;
S202: mixing natural rubber latex and maleic anhydride thoroughly, then adding 1% potassium persulfate on the total weight of the substrate and 0.5-1% by weight of ascorbic acid; under nitrogen protection, heating 70-80° C. and adjusting the pH to 5.5-6 with the acetic acid-sodium acetate buffer solution, stirring to react for 4-6 hours, centrifuging, filtering, and washing with deionized water to obtain grafted natural rubber;
S203: adding pullulan and polyvinyl alcohol to 6-10 times the weight of deionized water, heating to 50° C., and stirring to dissolve evenly; then, sequentially adding bio-based plasticizer, blue light absorber, silane-modified silica, and SA@TiO₂ core-shell pigment microcapsules, stirring and mixing evenly, then homogenizing three times at 100-150 Mpa to obtain premixed slurry;
S204: preheating the tannic acid-epoxy acrylate prepolymer prepared in S201 to 40-45° C., and slowly dropwise adding the grafted natural rubber prepared in S202 at 5 parts per minute; stirring and mixing at 800-1000 rpm, then adding the premixed slurry prepared in S203 in three batches, stirring and processing at 3000 rpm for 30-60 min, filtering through a 200-mesh nylon filter to obtain the ink.

The advantageous effects of the invention are as follows:
the invention creates an ink with eye-caring and environmentally friendly functions through a multi-dimensional synergistic mechanism. Specifically, the combination of Gardenia yellow and curcumin broadens the range of blue light absorption, compensating for the spectral gap of a single pigment. The TiO₂ shell layer enhances blue light scattering by using its high refractive index properties, forming a dual barrier of “absorption-scattering” with the core pigments to reduce blue light transmittance. The phenolic hydroxyl groups of curcumin bind to the surface of TiO₂ through coordinate covalent bonds, inhibiting the generation of free radicals excited by ultraviolet light, and blocking the chain reaction of pigment oxidation, while retaining the blue light scattering ability of TiO₂. The hydroxyl groups of pullulan and the carotenoids of Gardenia yellow form a complex through hydrogen bonding and hydrophobic interactions, enhancing dispersibility to improve blue light absorption efficiency and reduce the cumulative damage of high-energy photons to the retina. The phenolic hydroxyl groups of tannic acid form a dynamic reversible hydrogen bond network during the curing process of epoxy acrylate, imparting coating micro-region elasticity, which absorbs external mechanical impacts through localized deformation, preventing the rupture of core-shell pigment microcapsules due to stress concentration. The polyisoprene segments of natural rubber latex intercalate into the rigid epoxy network, forming a tough and flexible structure that reduces the risk of microcapsule rupture during the printing process and extends the lifespan of myopia-prevention functionality. Maleic anhydride, serving as a curing agent for epoxy acrylate, undergoes a ring-opening reaction between its anhydride group and the epoxy groups of the resin, forming a dense crosslinked network; this network restricts the molecular movement of SA@TiO₂ core-shell pigment microcapsules, thereby reducing photothermal degradation. Silane-modified silica bonds with maleic anhydride through ester linkages, enabling directional arrangement of particles, which decreases the disorderliness of light scattering and enhances the uniformity of blue light shielding. The high refractive index of TiO₂ and the low refractive index of silica create a gradient refractive interface, further boosting the efficiency of blue light shielding. Tannic acid (biobased) replaces petroleum-based monomers and copolymerizes with epoxy acrylate to enhance the biodegradability of the resin. Acetyl tributyl citrate combines with pullulan through hydrogen bonds to replace phthalic acid ester plasticizers to avoid migration and contamination. The sodium alginate shell prevents the pigment from directly contacting the solvent, reducing the amount of chemical solubilizers required. The TiO₂ shell layer isolates ultraviolet-induced pigment oxidation and decomposition, reducing the need for antioxidants. The hydrophobicity of natural rubber and the hydrophilicity of pullulan synergistically optimize the ink spreadability, reducing the potential for performance inconsistencies due to localized microcapsule enrichment. Both tannic acid and natural rubber are renewable resources, while pullulan assist in film formation and accelerate degradation. Polyvinyl alcohol and pullulan inhibit phase separation through multiple hydrogen bonds, further enhancing biodegradability and reducing pollution. The carboxylic acid groups of maleic anhydride-grafted natural rubber anchor silane-modified silica, improving interface compatibility. In summary, the invention utilizes various safe and environmentally friendly bio-based materials to construct a multi-layered synergistic protective system. Specifically, Gardenia yellow and curcumin core-shell pigments serve as the primary protection, covering the entire blue light spectrum; silane-modified silica diffuse reflection and pullulan act as the secondary protection, refracting and matching to scatter any residual blue light. The flexibility of tannic acid and epoxy acrylate combined with the elasticity of natural rubber form the tertiary protection, reducing the compensatory tension in the optic nerve caused by page-turning vibrations.

### 4. BRIEF DESCRIPTION OF ACCOMPANYING DRAWINGS

In order to explain the technical schemes in the embodiments of the invention or prior art more clearly, the accompanying drawings needed to be used in the description of the embodiments or the prior art will be briefly introduced below. Obviously, the accompanying drawings in the following description are only are some embodiments of the invention. For those of ordinary skill in the art, other accompanying drawings can be obtained based on these accompanying drawings without exerting creative efforts.

FIG. 1 is a graph showing the accelerated aging test results of the environmentally friendly anti-myopia ink prepared in Embodiment 2 and Comparative Examples 1 to 4 of the invention;

FIG. 2 is a SEM scanning electron microscope image of the plant-derived yellow pigment/SA@TiO₂ core-shell pigment microcapsules prepared in Embodiment 2 of the invention;

FIG. 3 is a graph showing the cyclic durability test results of the environmentally friendly anti-myopia ink prepared in Embodiment 2 and Comparative Examples 1 to 4 of the invention.

### 5. SPECIFIC EMBODIMENT OF THE INVENTION

The technical schemes in the embodiments of the invention will be clearly and completely described in combination with the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention. It should be noted that, except for the special description, the raw materials involved in the invention are purchased through conventional commercial channels.

Embodiment 1: an environmentally friendly anti-myopia ink comprises the following components in parts by weight: 45 parts of epoxy acrylate, 0.5 parts of maleic anhydride, 10 parts of tannic acid, 18 parts of natural rubber latex, 1.5 parts of bio-based plasticizer, 15 parts of plant-derived yellow pigment, 3 parts of blue light absorber, 5 parts of silane-modified silica, 0.5 parts of polyvinyl alcohol and 3 parts of pullulan.

The plant-derived yellow pigment is SA@TiO₂ core-shell pigment microcapsule, the SA@TiO₂ core-shell pigment microcapsule is prepared by compounding Gardenia yellow and curcumin and coating with sodium alginate/titanium dioxide core-shell, the specific preparation steps are as follows:
S1: dissolving 2.5 g of Gardenia yellow and 0.8 g of curcumin in 200 mL of PBS (phosphate-buffered saline), adding 50 mL of anhydrous ethanol and 3 mL of Tween-80, heating in a water bath to 40° C., stirring to mix evenly, and then homogenizing, with specific parameters: temperature 35° C., pressure 150 MPa, and 2 cycles of treatment, thereby obtaining a composite dispersion;
S2: dissolving 2 g of sodium alginate in 200 mL of deionized water, stirring to dissolve evenly, and letting it stand for 1 hour to obtain a 1 wt % sodium alginate solution; mixing 200 mL of sodium alginate solution with 200 mL of composite dispersion prepared in S1, emulsifying at 8000 rpm for 10 min, then dropwise adding 60 mL of 5% CaCl₂ solution, and continue stirring at 300 rpm for 30 min to react, thereby obtaining a microcapsule dispersion;
S3: slowly adding 0.1 mol/L of 40 mL of tetrabutyl titanate ethanol solution dropwise into 400 mL of ice bath deionized water, and adjusting the pH to 5 by using an acetic acid solution to obtain a transparent sol; mixing 400 mL of transparent sol with 400 mL of microcapsule dispersion prepared in S2, heating to 50° C., adding NaOH solution dropwise to adjust the pH to 7.5, stirring slowly at 200 rpm for 2 hours, and terminating the reaction by adjusting the pH to 6 with 0.1M hydrochloric acid solution, then centrifuging, filtering, and collecting precipitate, dispersing 2 g of precipitate in 200 mL of water solution containing 1% maltodextrin and 5% glycerol, and spray-drying with an inlet temperature of 100° C. and an outlet temperature of 90° C. to obtain SA@TiO₂ core-shell pigment microcapsules.

The specific preparation steps of the silane-modified silica are as follows:
S101: dispersing 1 g of nano-silica into 30 mL of anhydrous ethanol, dispersing it evenly by 200 W ultrasonic treatment for 30 min, adding 0.1M hydrochloric acid solution to adjust the pH to 3, and continuing ultrasonic treatment for 10 min to obtain a suspension;
S102: mixing 10 mL of KH-560 with 80 mL of anhydrous ethanol, stirring to mix uniformly, adding 12 mL of deionized water dropwise, adjusting the pH to 4.5 with acetic acid-sodium acetate buffer solution, heating in a water bath to 40° C., and stirring to react for 2 hours, thereby obtaining a hydrolyzate;
S103: mixing 30 mL of suspension prepared in S101 with 90 mL of hydrolyzate prepared in S102, heating to 70° C., stirring to react for 6 hours, centrifuging, filtering, washing repeatedly with anhydrous ethanol 3 times, and vacuum drying at 60° C. for 12 hours to obtain the silane-modified silica.

The preparation method of the environmentally friendly anti-myopia ink comprises the following specific preparation steps:
S201: adding epoxy acrylate and tannic acid into 20% by weight of propylene glycol methyl ether acetate, heating to 50° C. and stirring until completely dissolved, then adding 1.5% triphenylphosphine based on the total weight of the substrate, raising the temperature to 100° C. and reacting under nitrogen protection for 4 hours, removing the solvent by vacuum distillation at 60° C., washing repeatedly with deionized water three times, and vacuum drying to constant weight, thereby obtaining a tannic acid-epoxy acrylate prepolymer;
S202: mixing natural rubber latex and maleic anhydride thoroughly, then adding 1% potassium persulfate on the total weight of the substrate and 0.5% by weight of ascorbic acid; under nitrogen protection, heating 70° C. and adjusting the pH to 6 with the acetic acid-sodium acetate buffer solution, stirring to react for 4 hours, centrifuging, filtering, and washing with deionized water to obtain grafted natural rubber;
S203: adding pullulan and polyvinyl alcohol to 10 times the weight of deionized water, heating to 50° C., and stirring to dissolve evenly; then, sequentially adding acetyl trioctyl citrate, Blu-SHIELD B005, silane-modified silica, and SA@TiO₂ core-shell pigment microcapsules, stirring and mixing evenly, then homogenizing three times at 100 Mpa to obtain premixed slurry;
S204: preheating the tannic acid-epoxy acrylate prepolymer prepared in S201 to 40° C., and slowly dropwise adding the grafted natural rubber prepared in S202 at 5 parts per minute; stirring and mixing at 800 rpm, then adding the premixed slurry prepared in S203 in three batches, stirring and processing at 3000 rpm for 30 min, filtering through a 200-mesh nylon filter to obtain the ink.

Embodiment 2: an environmentally friendly anti-myopia ink comprises the following components in parts by weight: 50 parts of epoxy acrylate, 1 part of maleic anhydride, 15 parts of tannic acid, 25 parts of natural rubber latex, 3 parts of bio-based plasticizer, 15 parts of plant-derived yellow pigment, 1 part of blue light absorber, 8 parts of silane-modified silica, 1.5 parts of polyvinyl alcohol and 5 parts of pullulan.

The plant-derived yellow pigment is SA@TiO₂ core-shell pigment microcapsule, the SA@TiO₂ core-shell pigment microcapsule is prepared by compounding Gardenia yellow and curcumin and coating with sodium alginate/titanium dioxide core-shell, the specific preparation steps are as follows:
S1: dissolving 3 g of Gardenia yellow and 1 g of curcumin in 200 mL of PBS (phosphate-buffered saline), adding 58 mL of anhydrous ethanol and 3.5 mL of Tween-80, heating in a water bath to 45° C., stirring to mix evenly, and then homogenizing, with specific parameters: temperature 40° C., pressure 150 MPa, and 3 cycles of treatment, thereby obtaining a composite dispersion;
S2: dissolving 2.4 g of sodium alginate in 200 mL of deionized water, stirring to dissolve evenly, and letting it stand for 2 hours to obtain a 1.2 wt % sodium alginate solution; mixing 200 mL of sodium alginate solution with 200 mL of composite dispersion prepared in S1, emulsifying at 8000 rpm for 15 min, then dropwise adding 90 mL of 5% CaCl₂ solution, and continue stirring at 300 rpm for 50 min to react, thereby obtaining a microcapsule dispersion;
S3: slowly adding 0.1 mol/L of 40 mL of tetrabutyl titanate ethanol solution dropwise into 450 mL of ice bath deionized water, and adjusting the pH to 4.5 by using an acetic acid solution to obtain a transparent sol; mixing 400 mL of transparent sol with 400 mL of microcapsule dispersion prepared in S2, heating to 55° C., adding NaOH solution dropwise to adjust the pH to 8, stirring slowly at 200 rpm for 3 hours, and terminating the reaction by adjusting the pH to 6 with 0.1M hydrochloric acid solution, then centrifuging, filtering, and collecting precipitate, dispersing 2 g of precipitate in 200 mL of water solution containing 1% maltodextrin and 5% glycerol, and spray-drying with an inlet temperature of 105° C. and an outlet temperature of 85° C. to obtain SA@TiO₂ core-shell pigment microcapsules.

The specific preparation steps of the silane-modified silica are as follows:
S101: dispersing 1 g of nano-silica into 35 mL of anhydrous ethanol, dispersing it evenly by 200 W ultrasonic treatment for 50 min, adding 0.1M hydrochloric acid solution to adjust the pH to 2, and continuing ultrasonic treatment for 10 min to obtain a suspension;
S102: mixing 20 mL of KH-560 with 180 mL of anhydrous ethanol, stirring to mix uniformly, adding 26 mL of deionized water dropwise, adjusting the pH to 4 with acetic acid-sodium acetate buffer solution, heating in a water bath to 50° C., and stirring to react for 2.5 hours, thereby obtaining a hydrolyzate;
S103: mixing 35 mL of suspension prepared in S101 with 120 mL of hydrolyzate prepared in S102, heating to 80° C., stirring to react for 7 hours, centrifuging, filtering, washing repeatedly with anhydrous ethanol 3 times, and vacuum drying at 60° C. for 24 hours to obtain the silane-modified silica.

The preparation method of the environmentally friendly anti-myopia ink comprises the following specific preparation steps:
S201: adding epoxy acrylate and tannic acid into 20% by weight of propylene glycol methyl ether acetate, heating to 60° C. and stirring until completely dissolved, then adding 1.5% triphenylphosphine based on the total weight of the substrate, raising the temperature to 120° C. and reacting under nitrogen protection for 5 hours, removing the solvent by vacuum distillation at 60° C., washing repeatedly with deionized water three times, and vacuum drying to constant weight, thereby obtaining a tannic acid-epoxy acrylate prepolymer;
S202: mixing natural rubber latex and maleic anhydride thoroughly, then adding 1% potassium persulfate on the total weight of the substrate and 1% by weight of ascorbic acid; under nitrogen protection, heating 80° C. and adjusting the pH to 5.5 with the acetic acid-sodium acetate buffer solution, stirring to react for 5 hours, centrifuging, filtering, and washing with deionized water to obtain grafted natural rubber;
S203: adding pullulan and polyvinyl alcohol to 6 times the weight of deionized water, heating to 50° C., and stirring to dissolve evenly; then, sequentially adding acetyl tributyl citrate, Blu-SHIELD B005, silane-modified silica, and SA@TiO₂ core-shell pigment microcapsules, stirring and mixing evenly, then homogenizing three times at 150 Mpa to obtain premixed slurry;
S204: preheating the tannic acid-epoxy acrylate prepolymer prepared in S201 to 45° C., and slowly dropwise adding the grafted natural rubber prepared in S202 at 5 parts per minute; stirring and mixing at 1000 rpm, then adding the premixed slurry prepared in S203 in three batches, stirring and processing at 3000 rpm for 60 min, filtering through a 200-mesh nylon filter to obtain the ink.

Embodiment 3: an environmentally friendly anti-myopia ink comprises the following components in parts by weight: 48 parts of epoxy acrylate, 0.8 parts of maleic anhydride, 13 parts of tannic acid, 22 parts of natural rubber latex, 2.5 parts of bio-based plasticizer, 16 parts of plant-derived yellow pigment, 2 part of blue light absorber, 6 parts of silane-modified silica, 1 part of polyvinyl alcohol and 4 parts of pullulan.

The plant-derived yellow pigment is SA@TiO₂ core-shell pigment microcapsule, the SA@TiO₂ core-shell pigment microcapsule is prepared by compounding Gardenia yellow and curcumin and coating with sodium alginate/titanium dioxide core-shell, the specific preparation steps are as follows:
S1: dissolving 3.5 g of Gardenia yellow and 1.2 g of curcumin in 200 mL of PBS (phosphate-buffered saline), adding 60 mL of anhydrous ethanol and 4 mL of Tween-80, heating in a water bath to 42° C., stirring to mix evenly, and then homogenizing, with specific parameters: temperature 38° C., pressure 150 MPa, and 3 cycles of treatment, thereby obtaining a composite dispersion;
S2: dissolving 3 g of sodium alginate in 200 mL of deionized water, stirring to dissolve evenly, and letting it stand for 1.5 hours to obtain a 1.5 wt % sodium alginate solution; mixing 200 mL of sodium alginate solution with 200 mL of composite dispersion prepared in S1, emulsifying at 8000 rpm for 12 min, then dropwise adding 100 mL of 5% CaCl₂ solution, and continue stirring at 300 rpm for 40 min to react, thereby obtaining a microcapsule dispersion;
S3: slowly adding 0.1 mol/L of 40 mL of tetrabutyl titanate ethanol solution dropwise into 480 mL of ice bath deionized water, and adjusting the pH to 4.7 by using an acetic acid solution to obtain a transparent sol; mixing 400 mL of transparent sol with 400 mL of microcapsule dispersion prepared in S2, heating to 52° C., adding NaOH solution dropwise to adjust the pH to 7.8, stirring slowly at 200 rpm for 2.5 hours, and terminating the reaction by adjusting the pH to 6 with 0.1M hydrochloric acid solution, then centrifuging, filtering, and collecting precipitate, dispersing 2 g of precipitate in 200 mL of water solution containing 1% maltodextrin and 5% glycerol, and spray-drying with an inlet temperature of 110° C. and an outlet temperature of 85° C. to obtain SA@TiO₂ core-shell pigment microcapsules.

The specific preparation steps of the silane-modified silica are as follows:
S101: dispersing 1 g of nano-silica into 40 mL of anhydrous ethanol, dispersing it evenly by 200 W ultrasonic treatment for 40 min, adding 0.1M hydrochloric acid solution to adjust the pH to 2.5, and continuing ultrasonic treatment for 10 min to obtain a suspension;
S102: mixing 20 mL of KH-560 with 200 mL of anhydrous ethanol, stirring to mix uniformly, adding 30 mL of deionized water dropwise, adjusting the pH to 4.2 with acetic acid-sodium acetate buffer solution, heating in a water bath to 45° C., and stirring to react for 3 hours, thereby obtaining a hydrolyzate;

S103: mixing 40 mL of suspension prepared in S101 with 160 mL of hydrolyzate prepared in S102, heating to 70° C., stirring to react for 8 hours, centrifuging, filtering, washing repeatedly with anhydrous ethanol 3 times, and vacuum drying at 60° C. for 20 hours to obtain the silane-modified silica.

The preparation method of the environmentally friendly anti-myopia ink comprises the following specific preparation steps:
S201: adding epoxy acrylate and tannic acid into 20% by weight of propylene glycol methyl ether acetate, heating to 55° C. and stirring until completely dissolved, then adding 1.5% triphenylphosphine based on the total weight of the substrate, raising the temperature to 110° C. and reacting under nitrogen protection for 6 hours, removing the solvent by vacuum distillation at 60° C., washing repeatedly with deionized water three times, and vacuum drying to constant weight, thereby obtaining a tannic acid-epoxy acrylate prepolymer;
S202: mixing natural rubber latex and maleic anhydride thoroughly, then adding 1% potassium persulfate on the total weight of the substrate and 8% by weight of ascorbic acid; under nitrogen protection, heating 75° C. and adjusting the pH to 5.7 with the acetic acid-sodium acetate buffer solution, stirring to react for 6 hours, centrifuging, filtering, and washing with deionized water to obtain grafted natural rubber;
S203: adding pullulan and polyvinyl alcohol to 8 times the weight of deionized water, heating to 50° C., and stirring to dissolve evenly; then, sequentially adding acetyl castor oil methyl ester, Blu-SHIELD B005, silane-modified silica, and SA@TiO₂ core-shell pigment microcapsules, stirring and mixing evenly, then homogenizing three times at 120 Mpa to obtain premixed slurry;
S204: preheating the tannic acid-epoxy acrylate prepolymer prepared in S201 to 42° C., and slowly dropwise adding the grafted natural rubber prepared in S202 at 5 parts per minute; stirring and mixing at 900 rpm, then adding the premixed slurry prepared in S203 in three batches, stirring and processing at 3000 rpm for 50 min, filtering through a 200-mesh nylon filter to obtain the ink.

Comparative Example 1: the operation of Comparative Example 1 is basically the same as that of Embodiment 2, except that in Comparative Example 1, the core-shell packaging of Gardenia yellow and curcumin is not performed, but they are directly added to the ink for mixing.

Comparative Example 2: the operation of Comparative Example 2 is basically the same as that of Embodiment 2, except that pullulan is not added in Comparative Example 2.

Comparative Example 3: the operation of Comparative Example 3 is basically the same as that of Embodiment 2, except that silica is used to replace silane-modified silica in Comparative Example 3.

Comparative Example 4: the operation of Comparative Example 4 is basically the same as that of Embodiment 2, except that tannic acid is not added in Comparative Example 4.

### Performance Testing:

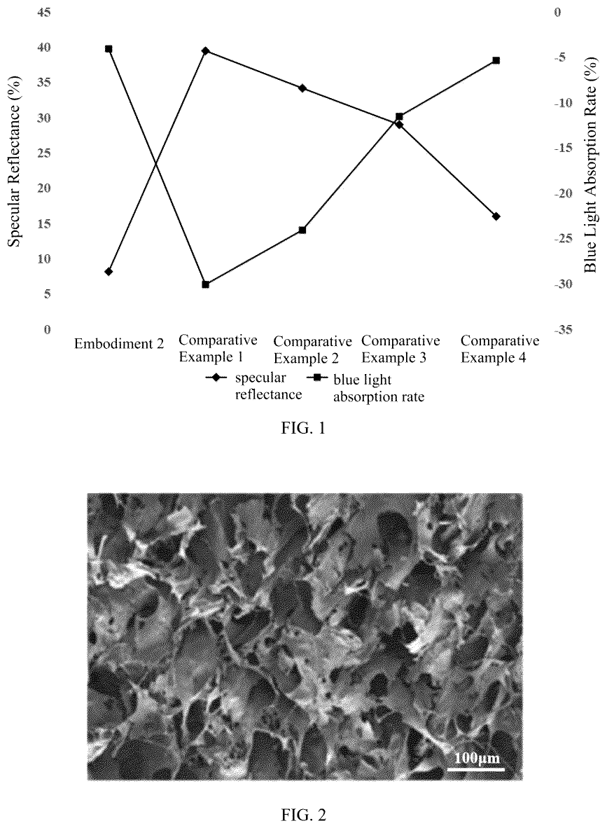

Accelerated Aging Test: the environmentally friendly anti-myopia ink prepared in Embodiment 2 and Comparative Examples 1-4 was coated onto paper (thickness 80 m), and after drying, it was tested by using a xenon lamp aging test chamber. The test parameters were 48±2° C., humidity 50±5%, and a test duration of 300 hours. The changes in the specular reflectance (%)=(Reflectance after aging−Initial reflectance)/Initial reflectance×100%, and the blue light absorption rate (%)=(Absorption value after aging−Initial value)/Initial value×100%. The results are shown in FIG. 1.

Based on the results presented in FIG. 1, the ink prepared in this invention exhibits excellent blue light resistance and weatherability, making it suitable for effective long-term use. Comparing the results of Comparative Example 1 with those of Embodiment 2, it is evident that uncoated Gardenia yellow and curcumin, when directly exposed to ultraviolet light and oxygen, undergo photooxidation. Curcumin, in particular, is light-sensitive, leading to the cleavage of conjugated double bonds and a loss of blue light absorption capacity. Furthermore, due to the absence of a core-shell composite structure, the absorption peaks of Gardenia yellow and curcumin cannot effectively complement each other, resulting in a narrowed coverage wavelength range. The results of Comparative Example 2 and Embodiment 2 indicate that the absence of pullulan may have caused agglomeration between SA@TiO₂ microcapsules and modified silica particles; this results in uneven pigment distribution within the coating, leading to localized absorption saturation and an overall decrease in absorption efficiency; additionally, undispersed microcapsules may form blind areas of optical scattering, allowing some blue light to pass through unabsorbed. From the comparison of Comparative Example 3 and Embodiment 2, it is apparent that ordinary silica has poor interfacial bonding with the resin and uneven particle distribution, which may lead to random scattering directions and increased ineffective reflections. The results of Comparative Example 4 and Embodiment 2 suggest that the absence of tannic acid may increase the brittleness of the resin, leading to microcracks in the coating, increasing surface roughness, thereby causing slightly impact reflectivity.

Spectrum Test: the SA@TiO₂ core-shell pigment microcapsule sample prepared in Embodiment 2 was placed on a SEM sample tray, fixed with a sticky carbon tape, covered with a layer of carbon by spraying, and the voltage was set to 10 kV by adjusting the parameters. The sample surface was scanned with an electron beam, and the SEM scanning electron microscope spectrum is shown in FIG. 2.

As shown in FIG. 2, the SA@TiO₂ core-shell pigment microcapsule prepared by the invention showed an obvious irregular shape in the image, and had features such as holes and depressions.

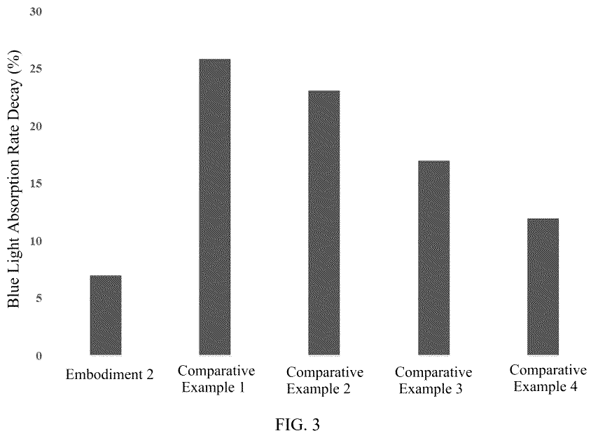

Cyclic Durability Test: the environmentally friendly anti-myopia ink prepared in Embodiment 2 and Comparative Examples 1-4 was coated (thickness 80 μm) and cured onto paper samples. These samples were fixed on the Tabor abrasion tester platform, with a non-woven fabric attached to the surface of the friction head. A 250 g weight was installed, and 5000 cycles of reciprocating friction were performed. The integral absorption rate of the test area in the 400-500 nm wavelength range was measured by using a UV-visible spectrophotometer. After the test, the blue light absorption rate decay (%)=(Pre-test integral absorption rate−Post-test integral absorption rate)/Pre-test integral absorption rate×100%. The results are shown in FIG. 3.

Based on the results presented in FIG. 3, the ink prepared in this invention demonstrates excellent durability, suitable for long-term effective use. Comparing the results of Comparative Example 1 with those of Embodiment 2, it is evident that uncoated Gardenia yellow and curcumin, when directly in contact with the friction medium, undergo physical abrasion and photooxidation under mechanical friction, leading to a significant decrease in absorption efficiency. Furthermore, the absence of a TiO₂ shell as a physical barrier results in direct damage to the pigment layer during friction, significantly shortening the blue light absorption path. The results of Comparative Example 2 and Embodiment 2 indicate that the absence of pullulan may have caused uneven dispersion of SA@TiO₂ microcapsules and modified silica particles, leading to rapid wear during friction and rapid failure of the local absorption layer; additionally, the lack of a hydrogen bonding network from pullulan reduces the adhesion between the coating and the substrate, making it prone to overall peeling during friction. From the results of Comparative Example 3 and Embodiment 2, it is evident that unmodified silica has weak interfacial bonding with the resin, causing particles to easily detach during friction, which shortens the light scattering path; moreover, ordinary silica may form micrometer-sized defects due to agglomeration, and these defects expand after friction, leading to increased scattering disorder. The results of Comparative Example 4 and Embodiment 2 suggest that the absence of tannic acid may have increased the rigidity of the resin network, causing microcracks to initiate under prolonged frictional stress concentration. The disruption of the absorption layer at these cracks results in a certain degree of decrease in absorption efficiency.

VOC Emission Test: the VOC emission data of the environmentally friendly anti-myopia ink prepared in Embodiments 1-3 were tested according to GB/T 23985-2009. The results are shown in Table 1 below.

TABLE 1
VOC Emission Test Results of Environmentally
Friendly Anti-Myopia Ink

| Indicators | Embodiment 1 | Embodiment 2 | Embodiment 3 | Blank |
|---|---|---|---|---|
| TVOC/(mg/m³) | 7.68 | 6.59 | 7.09 | 0.3 |
| Benzene/ | ND | ND | ND | ND |
| (μg/m³) | | | | |
| Toluene/ | ND | ND | ND | ND |
| (μg/m³) | | | | |
| Xylene/(μg/m³) | ND | ND | ND | ND |
| Formaldehyde/ | 4.01 | 3.15 | 3.59 | ND |
| (μg/m³) | | | | |

ND indicates not detected (<1 μg/m³).

From the results in Table 1, it can be seen that the environmentally friendly anti-myopia ink prepared in this invention achieves the environmental goal of no detectable Monoaromatic Hydrocarbons (MACHs), very low formaldehyde release, and compliance with TVOC standards through the optimization of natural raw material selection and ratio. It fully meets the health and sustainability requirements for anti-myopia inks.

Although the embodiments of the invention have been shown and described above, it should be understood that those skilled in the art can make changes, modifications, substitutions and alterations to the above embodiments without departing from the principles and spirit of the invention. The scope of the invention is defined by the claims and their equivalents.

1. An environmentally friendly anti-myopia ink, comprising the following components in parts by weight: 45-50 parts of epoxy acrylate, 0.5-1 parts of maleic anhydride, 10-15 parts of tannic acid, 18-25 parts of natural rubber latex, 1.5-3 parts of bio-based plasticizer, 15-18 parts of plant-derived yellow pigment, 1-3 parts of blue light absorber, 5-8 parts of silane-modified silica, 0.5-1.5 parts of polyvinyl alcohol and 3-5 parts of pullulan.

2. The environmentally friendly anti-myopia ink of claim 1, wherein the bio-based plasticizer is any one of acetyl tributyl citrate, acetyl trioctyl citrate, acetyl castor oil methyl ester and epoxidized soybean oil.

3. The environmentally friendly anti-myopia ink of claim 2, wherein the plant-derived yellow pigment is SA@TiO₂ core-shell pigment microcapsule, the SA@TiO₂ core-shell pigment microcapsule is prepared by compounding Gardenia yellow and curcumin and coating with sodium alginate/titanium dioxide core-shell, the specific preparation steps are as follows:
S1: dissolving Gardenia yellow and curcumin in PBS (phosphate-buffered saline), adding anhydrous ethanol and Tween-80, heating in a water bath, stirring to mix evenly, and then homogenizing to obtain a composite dispersion;
S2: dissolving sodium alginate in deionized water, stirring to dissolve evenly, and letting it stand to obtain a sodium alginate solution; mixing the sodium alginate solution with the composite dispersion prepared in S1, emulsifying, then dropwise adding a concentrated CaCl₂) solution, and continue stirring to react, thereby obtaining a microcapsule dispersion;
S3: slowly adding a tetrabutyl titanate ethanol solution dropwise into ice bath deionized water, and adjusting the pH by using an acetic acid solution to obtain a transparent sol; mixing the transparent sol with the microcapsule dispersion prepared in S2, heating, adding NaOH solution dropwise to adjust the pH, stirring slowly, and terminating the reaction by adjusting the pH with hydrochloric acid solution, then centrifuging, filtering, and collecting precipitate, dispersing the precipitate in a water solution containing maltodextrin and glycerol, and spray-drying to obtain SA@TiO₂ core-shell pigment microcapsules.

4. The environmentally friendly anti-myopia ink of claim 3, wherein in S1, the usage ratio of Gardenia yellow, curcumin and PBS (phosphate-buffered saline) is 2.5-3.5 g:0.8-1.2 g:200 mL, and specific parameters of the homogenization treatment are temperature 35-40° C., pressure 150 MPa, and 2-3 cycles of treatment.

5. The environmentally friendly anti-myopia ink of claim 4, wherein in S2, the volume ratio of the sodium alginate solution to the composite dispersion is 1:1; the amount of CaCl₂) solution added is 15-25% of the total volume of the sodium alginate solution and the composite dispersion; in S3, the volume ratio of the tetrabutyl titanate ethanol solution to the ice bath deionized water is 1:10-12; the volume ratio of the transparent sol to the microcapsule dispersion is 1:1.

6. The environmentally friendly anti-myopia ink of claim 5, wherein the specific preparation steps of the silane-modified silica are as follows:
S101: dispersing nano-silica into anhydrous ethanol, dispersing it evenly by ultrasonic treatment, adding hydrochloric acid solution to adjust the pH, and continuing ultrasonic treatment to obtain a suspension;
S102: mixing KH-560 with anhydrous ethanol, stirring to mix uniformly, adding deionized water dropwise, adjusting the pH with acetic acid-sodium acetate buffer solution, heating in a water bath, and stirring to react, thereby obtaining a hydrolyzate;
S103: mixing the suspension prepared in S101 with the hydrolyzate prepared in S102, heating, stirring to react, centrifuging, filtering, washing repeatedly with anhydrous ethanol, and vacuum drying to obtain the silane-modified silica.

7. The environmentally friendly anti-myopia ink of claim 6, wherein in S101, the usage ratio of nano-silica to anhydrous ethanol is 1 g:30-40 mL.

8. The environmentally friendly anti-myopia ink of claim 7, wherein in S102, the volume ratio of KH-560, anhydrous ethanol and deionized water is 1:8-10:1.2-1.5; in S103, the volume ratio of the suspension and the hydrolyzate is 1:3-4.

9. A preparation method of the environmentally friendly anti-myopia ink of claim 1, comprising the following specific preparation steps:
S201: adding epoxy acrylate and tannic acid into propylene glycol methyl ether acetate, heating and stirring until completely dissolved, then adding triphenylphosphine, raising the temperature and reacting under nitrogen protection, removing the solvent by vacuum distillation, washing repeatedly with deionized water, and vacuum drying to constant weight, thereby obtaining a tannic acid-epoxy acrylate prepolymer;
S202: mixing natural rubber latex and maleic anhydride thoroughly, then adding potassium persulfate and ascorbic acid; under nitrogen protection, heating and adjusting the pH with the acetic acid-sodium acetate buffer solution, stirring to react, centrifuging, filtering, and washing with deionized water to obtain grafted natural rubber;
S203: adding pullulan and polyvinyl alcohol to deionized water, heating, and stirring to dissolve evenly; then, sequentially adding bio-based plasticizer, blue light absorber, silane-modified silica, and SA@TiO₂ core-shell pigment microcapsules, stirring and mixing evenly, then homogenizing to obtain premixed slurry;
S204: preheating the tannic acid-epoxy acrylate prepolymer prepared in S201, and slowly dropwise adding the grafted natural rubber prepared in S202; stirring and mixing, then adding the premixed slurry prepared in S203 in three batches, stirring and processing, filtering through a 200-mesh nylon filter to obtain the ink.
